(19) United States
(12) Patent Application Publication
(10) Pub. No.: US 2016/0168024 A1
(43) Pub. Date: Jun. 16, 2016

(54) GLASS FIBRE RECOVERY

(71) Applicant: UNIVERSITY OF STRATHCLYDE, Glasgow (GB)

(72) Inventors: James THOMASON, Glasgow (GB); Eduardo Saez RODRIGUEZ, Glasgow (GB); Liu YANG, Glasgow (GB)

(73) Assignee: UNIVERSITY OF STRATHCLYDE, Glasgow (GB)

(21) Appl. No.: 14/907,488

(22) PCT Filed: Jul. 25, 2014
(86) PCT No.: PCT/GB2014/052280

§ 371 Date: Jan. 25, 2016

(30) Foreign Application Priority Data
Jul. 25, 2013 (GB) 1313298.0

(51) Int. Cl. C03C 25/66; C03C 25/70; C03C 25/40; C03C 14/00; C03C 13/00

(52) U.S. Cl. CPC C03C 25/66; C03C 14/00; C03C 13/00; C03C 25/40; C03C 25/70

(57) ABSTRACT

A method is disclosed for treating recovered glass fibre to restore the majority or substantially all of the mechanical strength that is otherwise lost during recovery of glass fibre from composite materials. Treated, recovered glass fibre is also disclosed.

### CROSS-REFERENCE TO RELATED APPLICATIONS

This application is a National Stage Entry of International Application No. PCT/GB2014/052280, filed on Jul. 25, 2014, which claims priority from Great Britain Patent Application No. 1313298.0, filed on Jul. 25, 2013, the contents of which are hereby incorporated by reference in their entirety.

### FIELD OF THE INVENTION

The invention relates to a method of recovering and recycling of glass fibre, and to materials, in particular fibre reinforced composite materials, comprising recycled glass fibre.

### BACKGROUND OF THE INVENTION

The disposal of end-of-life composite products in an environmentally friendly manner is one of the most important challenges facing the composites industry.

Glass fibre reinforced composites (also known generically as glass reinforced plastic, or “GRP”) account for approximately 90% of all fibre reinforced composites currently produced, and their production is predicted to increase, in line with increases in their use in, for example, automotive, aerospace and wind energy sectors.

Currently most of this composite material is destined for landfill at the end of its 10-25 year application lifetime. For example, the UK is already estimated to produce 160,000 Tons of GRP waste each year of which 98% goes to landfill.

Any form of recovery of glass fibre from GRP is generally regarded as being expensive or inefficient, however a number of processes are known. These include thermal, chemical or mechanical (e.g. grinding or fluidized bed) treatments, or combinations of these treatments.

Thermal recycling is probably the most technologically advanced and has been piloted in the UK and Denmark. However, the high temperatures required to separate the glass component from the matrix component of GRP materials (particularly composites comprising thermoset materials)—typically 400-700 Celsius—are well known to severely degrade the mechanical properties of even fresh glass fibre. Recovered fibre suffers a huge drop in mechanical performance of 80-90% in comparison to its original state. Other methods of recovering glass fibre also damage and mechanically degrade the fibre.

The degradation in the mechanical properties of the recovered glass fibre is not well understood, but is thought to relate to an increase in the number of surface flaws, such as cracks or other damage to the “quenched” surface layer of the glass fibre. Removal of some or all of the surface coating (or “sizing”) which is routinely applied to glass fibres during manufacture and/or some modification to the bulk structure of the glass, such as an increase in the density or size of intrinsic flaws, may also contribute to loss of mechanical strength.

Consequently, recovered glass fibre is considered unsuitable for use as reinforcement in composite materials and is therefore typically used as filler in cements, concrete and other applications were the fibre strength is not critical. For example, it has been proposed to grind GRP materials and drive off the plastics component in a cement kiln, so as to form cements comprising glass fibre fragments in the place of some or all of the more conventional aggregate component.

For these reasons, landfill is currently the most common way to dispose of end-of-life glass fibre reinforced composite material. However, expanding the use of the landfill option is increasingly perceived as environmentally and economically unacceptable.

Accordingly there is an increasing need for more effective and efficient ways to dispose of or recycle end of life glass fibre composite materials.

### SUMMARY OF THE INVENTION

According to a first aspect of the invention there is provided a method of treating recovered glass fibre, comprising;

elevating the temperature of a basic solution; and

treating the recovered glass fibre with the basic solution.

It has been found that recovered glass fibre has a much lower mechanical strength than fresh glass fibre. However, a significant proportion (and in some embodiments the majority or substantially all) of the mechanical strength may be recovered, following treatment in accordance with the present invention. The treated, recovered glass fibres may therefore subsequently used in the manufacture of new glass-fibre reinforced composite material.

The method may comprise treating the recovered glass fibre with the basic solution at an elevated temperature. The method may comprise elevating the temperature of the basic solution to an elevated temperature (for example for a predetermined period of time), and treating the recovered glass fibre at the same or another temperature (which may be higher or lower than the elevated temperature, and which may be ambient temperature).

By “treating” we mean bringing into contact with, including; spraying with, immersion in, deposition on (e.g. from the liquid, solution or vapor phase), application by a roller.

By “glass” we mean a substantially amorphous material comprising a major component of silicon dioxide and optionally one or more minor metal or metalloid oxide components. Glass materials in commercial use typically comprise a major component (i.e. the component present in the greatest molar percentage and typically greater than 50 mol %) of SiO₂, and one or more minor components (i.e. present at a lower mole percent than the major component, and typically less or much less than 50 mol %), for example, one or more of sodium, calcium, aluminium, magnesium, lead, potassium, zinc or zirconium oxide materials. Glass may comprise one or more further minor components, which may be non-oxide components, such as fluorine.

By “recovered glass fibre”, we mean glass fibre which as been recovered from a glass-fibre reinforced composite material (such as a material comprising glass fibre in a thermoset or thermoplastic matrix) or waste glass fibre which has been recovered from a process for making a glass-fibre reinforced composite material, or for making glass fibre mats or fabric for incorporation in a glass-fibre reinforced composite material, or waste glass fibre recovered from a glass fibre manufacturing process. The recovered glass fibre may, for example, be thermally recovered glass fibre, which has been recovered by thermally treating a glass fibre-reinforced composite material. Thermal treatment may decompose, pyrolyse or melt the matrix material. Thermally recovered glass fibre has typically been exposed to temperatures in the range of 300-700 Celsius.

In contrast, fresh glass fibres are glass fibres which have not been incorporated into a composite material, or which are not left over from mechanical processing to form mats or fabric. The term “fresh glass fibre” may include pristine fibres (newly formed and without a surface coating) and fresh fibres which have been coated, or “sized”, and which are ready to be incorporated into a composite material.

A glass-fibre reinforced material typically comprises a matrix material and glass fibres within the matrix. The glass fibres increase the strength of the composite material, in relation to the matrix material alone.

By “basic solution”, we mean a solution in which the concentration of the conjugate base of the solvent is elevated in comparison to its concentration in the pure solvent. For example, the solution may be an aqueous solution, with an elevated hydroxide ion concentration ([⁻OH]), or may be an alcoholic solution, with an elevated [RO⁻] (where RO⁻is, for example, an alkoxide ion).

By “mechanical strength” we mean the stress or strain at the breaking point of a glass fibre, and in particular the tensile stress at breaking point along the length of a fibre, as measured by standard procedures including; ASTM 2256-02, ASTM D3822-07, ASTM D3379-75,ASTM C1557-03, ASTM 638. In relation to glass fibre or recovered glass fibre material comprising a plurality of individual fibres, the mechanical strength relates to a mean value or values.

The method may comprise treating the recovered glass fibre with a high pH (i.e. aqueous) solution. A high pH solution may have a pH of greater than approximately pH 8 (at room temperature). The method may comprise treating the recovered glass fibre at a pH above around pH 9, or above around pH 10. The method may comprise treating the recovered glass fibre at a pH in the range of around pH 10-15, or 12-14. It will be understood that pH of a solution may exhibit temperature dependence, and that the pH of a solution may increase or decrease with temperature.

By “elevated temperature”, and “elevating the temperature to”, we refer to a temperature significantly above ambient temperature. The ambient temperature during glass fibre processing is typically in the range of approximately 15 or 20° C. to approximately 25 or 30° C.

The method may comprise elevating the temperature of a basic solution to (e.g. treating the recovered glass fibre with a basic solution at an elevated temperature of) above around 30 Celsius, above around 50 Celsius, or above around 60, 70, 80 or 90 Celsius, at atmospheric pressure. The temperature of the basic solution may be elevated to an elevated temperature of between around 30-100 Celsius, 50-100 Celsius, 60, 70, 80, or 90-100 Celsius, at atmospheric pressure. The temperature of the basic solution may be elevated to an elevated temperature of between around 75-95 Celsius, or between around 85 or 90-95 Celsius.

The method may comprise treating the recovered glass fibre with a basic solution for between around 1 minute to around 24 hours. In some embodiments, the recovered glass fibre is treated with a basic solution for between around 3 minutes to one hour, or between around 1-30 minutes, or 3-20 minutes. The method may comprise treating the recovered glass fibre with a basic solution for around 5-10 minutes.

The basic solution may comprise a solution of a base selected from the group including, but not limited to, a hydroxide salt, an ammonium salt (primary, secondary or tertiary), an amide, an alkoxide, a silane, a siloxane. The basic solution may comprise a solution of a hydrolyzed or partially hydrolysed silane (which may comprise silane monomers and/or siloxane oligomers).

The basic solution may comprise a metal hydroxide solution, for example a sodium hydroxide or a potassium hydroxide solution.

The hydroxide solution may be an aqueous solution. The concentration of the hydroxide solution may be above around 1 M (i.e. 1 Mol/dm³ at stp), or 2 M. The concentration of the hydroxide solution may be around 3 M.

The method may comprise treating the recovered glass fibre with a coating formulation.

The method may comprise treating the recovered glass fibre with a coating formulation at elevated temperature.

Pristine glass fibre is conventionally treated with a coatings formulation at ambient temperature. Similar treatment of recovered glass fibre only with a coating formulation which has remained at ambient temperature does not result in any increase in the mechanical strength of the fibres (in comparison to their strength immediately following recovery). However, it has surprisingly been found that treating the recovered glass fibre in accordance with the present invention results in an increase of the mechanical strength of recovered glass fibre. The method of the present invention provides for restoration of a significant proportion (and in some embodiments the majority or substantially all) of the mechanical strength of the glass fibre which has been lost during recovery of the glass fibre, for example from a composite material.

In some embodiments, between around 25-100% of the mechanical strength is restored. Around or more than 40% or 60% or 80% of the mechanical strength may be restored.

The method may comprise treating the recovered glass fibre with a coating formulation at ambient temperature.

The coating formulation may be a basic solution. The basic solution may be a coating formulation.

The method may comprise treating the recovered glass fibre with a basic solution and subsequently treating the recovered glass fibre with a coating formulation. One or both of the treatments may be at elevated temperature. Treating the recovered glass fibres with both a basic solution and a coating formulation (which may optionally also be a basic solution) may restore a greater proportion of the mechanical strength than either of the treatments alone.

It has however been found that if both the basic solution and coating formulation treatments (or the treatment, where only one such treatment is conducted) is conducted at ambient temperature, restoration of the mechanical strength of the fibre is much reduced, or minimal.

The method may comprise treating the recovered glass fibre with a coating formulation for between around 3 minutes to around 24 hours. In some embodiments, the recovered glass fibre is treated for between around 1 to 24 hours. Alternatively, or in addition, the method may comprise elevating the temperature of a coating formation (e.g. a silane solution) for between around 1 to 24 hours (e.g. around 5 hours). The optimum duration of treatment with the coating formulation may depend on factors including the method of treatment (i.e. whether by immersion, dipping and curing, etc.) the temperature or acidity/basicity of the solution, the composition of the coating formulation the nature of the recovered glass fibre surface, the desired coating thickness to be deposited, as know to those skilled in the art.

The coating formulation may comprise a solution or a dispersion of a coatings material, comprising for example one or more polymers (such as a polyester, polypropylene, polyurethane or a polyamide, polysiloxane), resins (such as an epoxy resin or a polyester resin), oligomers (such as siloxane oligomeric species, resulting from hydrolysis of silane monomers) or monomers (such as a urethane, silane, organosilane or aminosilane, or a siloxane). The coating formulation may comprise a coupling agent (such as a silane, siloxane, organosilane or aminosilane, or a silanol), or a cross linking agent (such as a diol or a diamine). The coating formulation may comprise a combination of such materials, or additional components as known to those skilled in the art of applying coatings, or “sizings” to glass fibre.

The method may comprise one or more in-situ processes (by which we mean processes which take place on or near the surfaces of the recovered glass fibres), including in-situ chemisorption (e.g. of a polymer, resin, monomer or coupling agent), physisorption (e.g. of a polymer or resin), polymerisation or co-polymerisation, curing (e.g. by cross linking of polymer chains, or curing of a resin), coupling (between a coupling agent and a recovered glass fibre surface).

The coating formulation preferably comprises an organosilane, and may comprise a solution (e.g. an aqueous solution) of an organosilane.

The organosilane may be of the general form: Rₙ—Si—X₍₄₋ₙ₎

where;

R is a non-hydrolysable organic moiety

X is a hydrolysable moiety.

The coating formulation may comprise a solution of a hydrolysed or partially hydrolysed organosilane (which may comprise silane monomers, silanols and/or oligomeric siloxane species).

When a recovered glass fibre is treated with a coating formulation comprising an organosilane solution (or a partially hydrolysed solution thereof), the hydrolysable moieties X may be displaced by hydroxyl groups present on the glass surface, or hydrolysed (i.e. replaced by hydroxide groups by reaction with water), so as to form covalent bonds to the recovered glass fibre surface and/or to other species in the solution, such as silane molecules or oligomeric siloxane species. Thus, the recovered glass fibre may be coated with regions of chemisorbed siloxane oligomers and/or regions of chemisorbed polysiloxane, formed from hydrolysis of the silane monomers.

Each of the n R moieties may be selected independently from; an alkyl group, an aromatic group, an organofunctional group.

By organofunctional group, we mean a hydrocarbon group, which may be straight chain or branched, saturated or comprising one or more unsaturated bonds, and comprising one or more functional groups capable of covalently reacting with other functional groups (which may be the same or different), the functional groups being selected from the list including, but not exclusively; acrylate, alkenyl, alkoxy, alkynyl, amine, amide, carbonyl, carboxylate, cyanate, epoxy, ester, ether, halide, imine, methacrylate, nitrate, nitrile, phosphate, sulphate, thiol, vinyl. Other functional groups may be present, as will be appreciated by a person skilled in the art of silane chemistry.

The organofunctional group may be selected so as to be capable of reacting with other organic species which are present in the coating formulation, for example so as to covalently bond to monomers/polymers/resins deposited on the recovered glass fibre. The organofunctional group may be selected so as to be capable of reacting with a matrix material of a glass-reinforced composite material comprising treated, recovered glass fibre, as discussed in further detail below.

Each X may be an alkoxy-group, which may be substituted, unsubstituted, branched or straight chain. Each X group may (independently) have the formula —CₘH₍ₘ₊₁₎, where m=1 to 10. Each X may be a methoxy or an ethoxy group.

Alkoxy groups are readily hydrolysed and/or displaced by hydroxyl groups present on a glass surface.

The coating formulation may comprise an aminopropyltriethoxysilane (APS) solution, a methacyloxypropyltrimethoxysilane (MPS) solution, a glycidoxypropyltrimethoxysilane (GPS) solution, a metcaptopropyltrimethoxysilane (SPS) solution, and/or a vinyltriethoxysilane (VS) solution.

The coating formulation may comprise an aminopropyltriethoxysilane (APS) solution, and in particular a γ-aminopropyltriethoxysilane solution. The coating formulation may comprise a methacyloxypropyltrimethoxysilane (MPS) solution, and in particular a γ-MPS solution.

The coating formulation may comprise more than one type of organosilane (or the hydrolysis products thereof).

The method may comprise treating the recovered glass fibre with a first coating formulation and a second coating formulation. For example, the method may comprise treating the recovered glass fibre with a first coating formulation, so as to deposit a layer of chemisorbed polysiloxane on the surfaces of the recovered glass fibre, and treating with a second coating formulation, so as to deposit a layer of another material over the polysiloxane layer.

The basic solution or the coating formulation may comprise a co-solvent. For example, a said solution may be aqueous, and may comprise an alcohol co-solvent.

The method may comprise heating (i.e. so as to raise the temperature of) the basic solution and/or the coating solution. The method may comprise heating the recovered glass fibre.

The recovered glass fibre may initially be at a lower temperature (e.g. ambient temperature) than the basic solution, or coating formulation. Treating with a basic solution/coating formulation at an elevated temperature may cause the recovered glass fibre to be heated to the elevated temperature.

The recovered glass fibre may initially be at an elevated temperature and may be at a higher temperature than the basic solution/coating formulation. In some cases, the recovered glass fibre may be at a very much higher, for example if the recovered glass fibres are treated with the basic solution immediately following thermal recovery from a glass fibre reinforced composite material). The basic solution/coating formulation may be heated to an elevated temperature by contact with the recovered glass fibre.

In some embodiments, both the recovered glass fibre and the basic solution/coating formulation may be heated, for example from initial treatment at ambient temperature to an elevated temperature.

The method may comprise one or more steps of washing the recovered glass fibre.

The recovered glass fibre may be washed before treatment with a basic solution (for example as part of the process of recovering the glass fibre), or washed after treatment with a basic solution. The method may comprise one or more intermediate washing steps (i.e. between treatments with basic solutions and/or coatings formulations).

The recovered glass fibre may be washed with water, an aqueous solution and/or a non-aqueous solvent or solution.

The recovered glass fibre may be washed with an acidic or a basic solution (which may be a weakly acidic or basic solution, or may be a strong acidic or basic solution).

Washing with an acidic or basic solution may remove surface residue, such as residual surface coating, or chemicals or deposits remaining from an earlier treatment. For example, it has been found that in some circumstances, treatment with a basic solution causes deposits to be formed. An acidic solution may dissolve such deposits and may prepare the glass surface for subsequent treatment with a coating formulation. The effect of washing to remove deposits may be a function of concentration, time and/or temperature. For example, washing at a higher concentration, and/or at a higher temperature may dissolve more deposits, or may dissolve deposits more rapidly.

Washing with an acidic or basic solution may also modify the acidity/bacicity of the surface. Certain in-situ chemical reactions (such as chemisorption, polymerisation or cross linking) which take place during or after treatment with a coating formulation may be pH dependent and washing prior to coating may advantageously reduce or increase the concentration of acidic or basic species present on or forming a part of the glass surface, for example surface hydroxyl groups with which chemisorption may take place.

The recovered glass fibre may be washed at ambient temperature. Alternatively, or in addition, the recovered glass fibre may be washed at an elevated temperature (which need not be the same temperature as preceding or subsequent treatments).

The recovered glass fibre may be washed with an aqueous mineral acid, such as hydrochloric acid.

Each wash may be conducted for less than an hour, or less than 15 minutes. Each wash may be conducted for around a minute, or around 5 minutes.

The method may comprise successive washes. For example, the method may comprise a first wash, to remove surface residue, and a second wash to modify the acidity/bacicity of the surface.

According to a second aspect of the invention, there is provided a method of recycling glass fibres from glass-fibre reinforced composite material, the method comprising; recovering glass fibre from the glass-fibre reinforced composite material; elevating the temperature of a basic solution; and treating the recovered glass fibre with the basic solution.

The glass fibre may be recovered by a thermal treatment. The thermal treatment may comprise exposing the composite material to a temperature in excess of 300 Celsius, or a temperature in the range of 400-600 Celsius, or at a temperature of around 450 Celsius, 500 Celsius, 550 or 600 Celsius. The composite material may be exposed to a temperature in the range of 300-700 or 400-700 Celsius.

Thermal treatment may cause a matrix material of the glass-fibre reinforced composite material to melt, vaporise and/or decompose. It is however known that thermal treatment of glass fibres (indeed even of fresh glass fibres not previously embedded in a matrix material) causes a degradation of their mechanical strength, whereas in accordance with the invention a significant proportion of the lost mechanical strength can be recovered by way of treatment in a basic solution at elevated temperature.

Thermal treatment may also remove some or substantially all of a surface coating of the glass fibre.

Alternatively, or in addition (sequentially or simultaneously) the glass fibre may be recovered by a mechanical and/or chemical treatment (to dissolve or erode a matrix material). For example, the glass-fibre reinforced material may be ground and then chemically or thermally treated, for example within a fluidized bed. Indeed, in order to remove a matrix material, a chemical treatment may in some instances be performed at a very high temperature, for example above around 200 Celsius, or around 200-300 Celsius.

The method may comprise recovering glass fibre from the glass-fibre reinforced composite material; and subsequently elevating the temperature of a basic solution and treating the recovered glass fibre with the basic solution (for example after the recovered glass fibres have been separated from a chemical treatment medium and/or from a matrix material or components thereof).

Further preferred and optional features of treating the recovered glass fibre correspond to features described in relation to the first aspect.

In a third aspect, the invention extends to a method of preparing a glass-fibre reinforced composite material, comprising elevating the temperature of a basic solution; treating recovered glass fibre with the basic solution; and embedding the treated, recovered glass fibre in a matrix material.

The matrix material may be a thermoplastic or a thermoset matrix material. The method may comprise curing the matrix material (e.g. so as to polymerise or cross link the matrix material, or to cause covalent bonding between the matrix material and a coating on the surfaces of the treated, recovered glass fibre).

The method may comprise recovering glass fibre from a first glass-fibre reinforced composite material; elevating the temperature of a basic solution and treating the recovered glass fibre with the basic solution; and embedding the treated, recovered glass fibre in a matrix material, so as to form a second glass-fibre reinforced composite material.

The method may comprise thermally recovering the glass fibre, e.g. from the first glass-fibre reinforced composite material.

The method may comprise separating the recovered glass fibre, e.g. from a chemical treatment medium and/or from a matrix material or components thereof. Separation may comprise filtering, drying or settling. Recovering the glass fibre from a first glass-fibre reinforced composite material may comprise separating the recovered glass fibre from a chemical treatment medium and/or from a matrix material or components thereof and subsequently elevating the temperature of a basic solution; and treating the recovered glass fibre with the basic solution.

The method may comprise sorting the recovered glass fibre, or the treated, recovered glass fibre, by size.

Preferred and optional features of the steps of recovering the glass fibre and of treating the recovered glass fibre correspond to preferred and optional features of the first and second aspects.

According to a fourth aspect of the invention, there is provided treated, recovered glass fibre, obtainable by elevating the temperature of a basic solution and treating recovered glass fibre with the basic solution. The method may comprise treating the recovered glass fibre with a basic solution at elevated temperature.

According to a fifth aspect of the invention there is provided a glass-fibre reinforced composite material, obtainable by;

elevating the temperature of a basic solution and treating recovered glass fibre with the basic solution; and

embedding the treated, recovered glass fibre in a matrix material.

The method may comprise recovering glass fibre from the matrix material of a glass-fibre reinforced composite material; elevating the temperature of a basic solution and treating the recovered glass fibre with the basic solution.

The treated, recovered glass fibre may be obtainable by the method of the first or second aspect. The recovered glass fibre may be obtainable by recycling glass fibre by the method of the second aspect.

The treated, recovered glass fibre may comprise a surface coating, such as a chemisorbed polysiloxane surface coating.

The treated, recovered glass fibre may comprise modified surface flaws, characterised by one or more of; eroded surface features, such as blunted cracks or flaws; etched and flawless surface regions (i.e. regions in which the quenched surface layer and any flaws in that layer have been etched away); bridged cracks or flaws (which may for example be formed be a basic silane solution)

In silicate glasses, a surface crack (a type of flaw) has a radius of curvature normal to the direction or plane of the crack) on the order of 0.3 nm at its tip, which is approximately the size of a single siloxane bridge [Si—O—Si]. A crack which has been blunted by erosion with a basic solution may have a much larger radius of curvature, for example on the order of 1 nm, or 10 nm.

The treated, recovered glass fibre may comprise, micro-scale or nano-scale deposits, which may be crystalline at least in part. The treated, recovered glass fibre may comprise residual polysiloxane coating (or other polymeric) coating. The deposits and/or residual coating may be under a surface coating, applied to recovered fibres by treatment with a coating formulation.

The crystalline deposits may comprise silicates (e.g. sodium silicate Na₂SiO₃), hydroxides (e.g. Ca(OH)₂) or salts of complex oxy- or hydroxyl anions (e.g. aluminates such as Na₃Al(OH)₆, or borates).

The process of recovering glass fibres from a matrix material typically results in removal of a substantial portion, or in some cases all, of an existing coating of polymeric material. Similarly, treatment of recovered glass fibres may cause deposition (or growth) of crystalline materials on the surfaces thereof. A recovered glass fibre may therefore comprise regions of bare glass surface surrounding isolated regions of a coating or a deposit.

Thus, the invention extends in a sixth aspect to treated, recovered glass fibre comprising modified surfaces characterised by one or more of; eroded surface features, such as blunted cracks or flaws, or etched and flawless surface regions; bridged cracks or flaws, micro-scale or nano-scale crystalline deposits. The invention extends in a seventh aspect to a glass-fibre reinforced composite material (or an article comprising or consisting thereof), comprising the treated, recovered glass fibre of the other aspects, embedded in a matrix material.

Further preferred and optional features of each aspect of the invention correspond to preferred and optional features of any other aspect of the invention.

### DESCRIPTION OF THE DRAWINGS

Non-limiting example embodiments of the invention will now be described, with reference to the following drawings in which:

FIG. 1 shows a glass fibre bundle suspended from a steel rig.

FIG. 2 shows bundle tensile test results of bare GF bundles treated with different silanes at pH 5 and at ambient temperature.

FIG. 3 shows bundle tensile test results of bare GF bundles treated with different silane blends at pH 5 and at ambient temperature.

FIG. 4 shows bundle tensile test results of bare GF bundles 1-8 treated with 1% APS aqueous solutions, under the conditions set out in Table 2.

FIG. 5 shows bundle tensile test results of bare GF bundles 1-2 treated with 2% APS aqueous solutions, under the conditions set out in Table 3.

FIG. 6 shows bundle tensile test results of bare GF bundles 1-4 treated with MPS aqueous solutions, under the conditions set out in Table 4.

FIG. 7 shows single fibre tensile test results of single fibres obtained from a silane-treated bundle, and individual fibres which have been treated with silane. Materials were treated with hot 1% APS(aq) for 15 minutes.

FIG. 8 shows average single fibre strength for fibres obtained from GF bundles following heat treatment of Owens Corning APS coated GF bundles at 450° C., and the treatments set out in Table 5.

FIG. 9 shows average single fibre strength for fibres obtained from GF bundles following heat treatment of Owens Corning APS coated GF bundles at 400° C., and the treatments set out in Table 6.

FIG. 10 shows example SEM images of heat treated glass fibres (400° C., 25 mins), following treatment with 3M NaOH for 5 hours at 95° C.

FIG. 11 shows example SEM images of the of heat treated glass fibres (400° C., 25 mins), following treatment with 3M NaOH for 5 hours at 95° C., following a subsequent wash in 37% HCl(aq) for 1 minute.

FIG. 12 shows average single fibre strength for fibres obtained from GF bundles following heat treatment of Owens Corning APS coated GF bundles at 400° C., and the treatments set out in Table 8.

FIG. 13 shows average single fibre strength for fibres obtained from GF bundles following heat treatment of Owens Corning APS coated GF bundles at 400° C., 450° C., 500° C. and 600° C., and the treatments set out in Table 9.

FIG. 14 shows results of tensile strength and unnotched impact tests conducted on (a) injection molded polypropylene material (b) injection molded polypropylene material mixed with 30% by weight of fresh 3B coated fibreglass (coating product no. DS 2200-13P) (c) injection molded polypropylene material mixed with 30% by weight of the DS 2200-13P fiberglass which has been subjected to heat treatment at 500° C. for 25 mins (d) injection molded polypropylene material mixed with 30% by weight of the DS 2200-13P fiberglass which has been subjected to heat treatment at 500° C. for 25 mins and then treated with aminosilane solution at 83° C. for 15 mins. (3B is a trademark of 3B-Fiberglass sprl, Battice, Belgium).

### DETAILED DESCRIPTION OF EXAMPLE EMBODIMENTS

Materials

The glass fibres (“GFs”) used in this study were bare and γ-Aminopropyltriethoxy silane (APS) “sized” (i.e. surface coated) Advantex E-glass GFs provided by Owens Corning. Advantex is a trade mark of Owens Corning Average fibre diameter was measured as 17 μm with standard deviation of 1.6.

The silane “sizings” used in this study, are set out in Table 1 below, together with their abbreviations (“Designation”) and chemical structures.

TABLE 1

| Designation | Sizing | Chemical structure |
|---|---|---|
| VS | Vinylthriethoxy Silane | 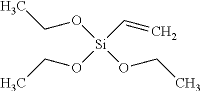 |
| M-PS | γ- Methacryloxypropylthrimethoxy Silane | 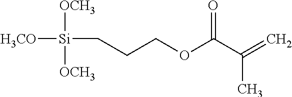 [SMILES: C=C(C)C(=O)OCCC[Si](OC)(OC)OC] |
| GPS | γ-Glycidoxypropyltrimethoxy Silane | 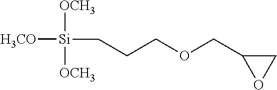 [SMILES: CO[Si](CCCOCC1CO1)(OC)OC] |
| SPS | γ-Mercaptopropyltrimethoxy Silane | 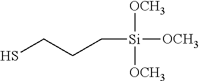 [SMILES: CO[Si](CCCS)(OC)OC] |
| APS | γ-Aminopropyltriethoxy Silane | 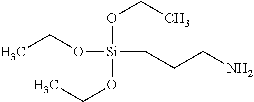 |

Experimental Procedures:

Thermal Treatment

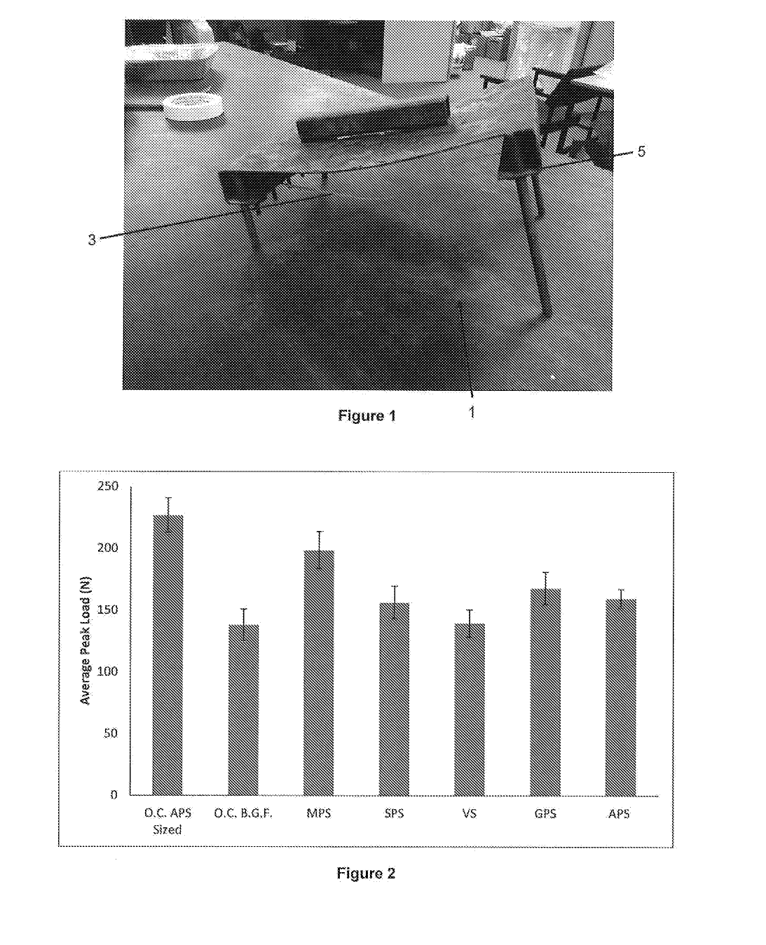

Thermal treatment of glass fibre bundles was conducted by securing fibre bundles from a steel rig 1. Each glass fibre bundle 3 was suspended from the steel rig 1 using a nut, bolt and washer arrangement 5 at each end of the bundle (to prevent fibre breakage), as shown in FIG. 1.

Glass fibre bundles were heat treated under the following conditions:
(i) 400° C. for 25 minutes.
(ii) 450° C. for 25 minutes.
(iii) 500° C. for 25 minutes.
(iv) 600° C. for 25 minutes.

Once the furnace had been preheated to the required temperature (400° C., 450° C., 500° C. or 600° C.) over the course of 1 hour, the rig was inserted into the furnace for 25 minutes. Thereupon it was removed from the furnace and left to cool to room temperature.

HCl Treatment

Heat treated GFs bundles were immersed in a 10% v/v aqueous solution of HCl for 1 hour at room temperature. The GFs bundles were then rinsed in deionized water for at least 1 minute.

If no further treatments were applied, the GFs bundles were then dried in a preheated oven at 110° C. for 15 minutes (using the steel rig, as described above).

NaOH Treatment

Aqueous NaOH solutions of 1.5M and 3M concentration were prepared from NaOH pellets. A series of treatments were performed in which GF bundles were immersed in NaOH(aq) for periods of between 5 minutes and 3 hours, at an elevated temperature of 95° C.

Silane Treatments

Aqueous solutions of each silane in Table 1, and certain blends of the silanes, were prepared. Prior to treatment of the glass fibre, each solution was left to hydrolyze for 24 hours, or heated to between 75° C. to 90° C. for 4.5-5 hours.

With the solution ready to be applied, each GF sample was completely immersed in a selected silane solution for 15 minutes at room temperature.

Variations to this treatment were also investigated, including immersion of a GF bundle during the hydrolysing process, immersion for longer periods, hydrolysis and/or immersion at elevated temperature.

The samples were then removed from the solutions and dried in an oven at 110° C. for overnight (using the steel rig, as described above).

Treatments were also applied to individualised bare glass fibres.

Bundle Tensile Test

Treated GF bundles were bonded within a 250 mm template using epoxy resin. Care was taken during this process not to subject the samples to further mechanical stress.

The tensile strength of between 10-20 samples of each treatment (or combination of treatments) following the method of ASTM 2256-02, using the Testometric M250-2CT instrument. A 2.5 kN load cell was used for these tests and a ramp rate of 3.75 mm/min was applied, resulting in a 1.5 strain/min for the gauge length of 250 mm.

Single Fibre Tensile Test

Individual fibres were bonded within a 20 mm template using a cyanoacrylate adhesive. Care was taken during this process not to subject the samples to further mechanical stress.

An Olympus optical microscope and ImageJ software was used to measure the diameter of each fibre (with accuracy of approximately±1 μm).

The tensile strength of between 30-60 samples of each treatment were tested following the ASTM standard D3822-07 using an Instron Tensile Testing 3342 instrument, at room temperature. A 10N load cell was used for these tests and a ramp rate of 0.3 mm/min was applied, resulting in a 1.5% strain/min for the gauge length of 20 mm.

Scanning Electron Microscopy (SEM)

Samples were coated in gold using an Edwards S150 sputter coater and SEM images were obtained using a HITACHI SU-6600 scanning electron microscope. SEM images were acquired of GFs surfaces, before and after chemical and/or silane treatments, as described below.

Experimental Results

Bundle Tensile Test Results

The experimental stress strain curves were quite linear, unsurprisingly in brittle materials. The results of the average peak load (i.e. maximum applied load prior to bundle breakage) are shown in FIGS. 2 to 6. Error bars show 95% confidence limits.

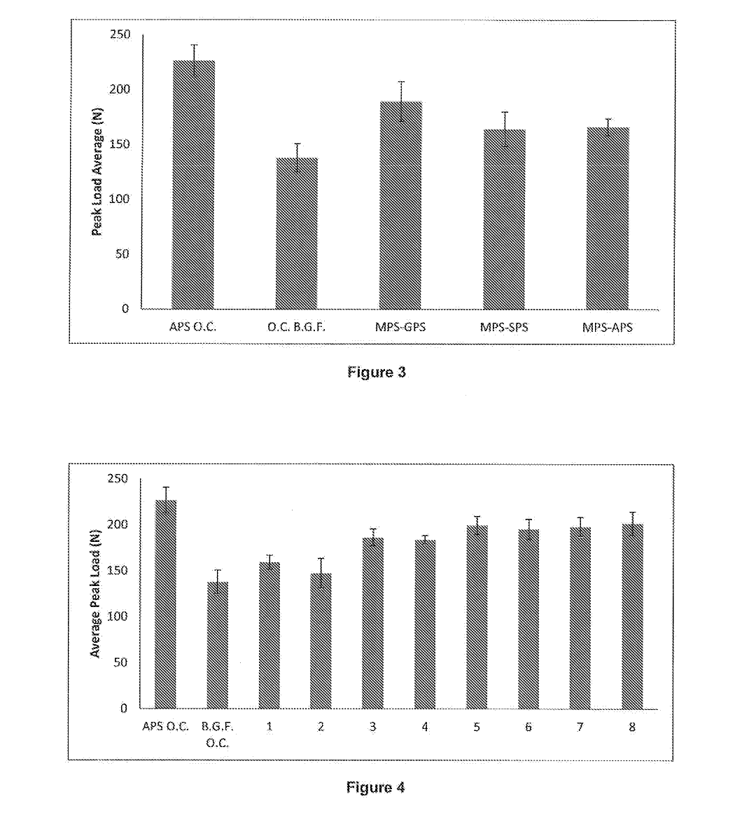

FIGS. 2 and 3 shows bundle tensile test results of silane treated GF bundles (treatment at ph5 and at ambient temperature), compared to a bundle tensile test of a commercially available APS-sized glass fibre (first column of FIGS. 2 and 3, labelled “APS O.C.”) and a bare glass fibre sample (labelled “O.C. BGF”). The commercially available APS-sized sample was prepared by application of a coating formulation at ambient temperature, to freshly drawn glass fibres. These data demonstrate the strength of fibre bundles following application of silane coatings formulations under conventional conditions.

The 1% v/v APS(aq) treatment conditions used for samples 1-8, shown in FIG. 4, are set out in table 2, below.

TABLE 2

| APS | 1 | 2 | 3 | 4 | 5 | 6 | 7 | 8 |
|---|---|---|---|---|---|---|---|---|
| pH water | 5 | Natural | Natural | Natural | Natural | Natural | Natural | Natural |
| Hydrolyzation | 24 | 1 | 5 | 5 | 5 | 5 | 5 | 24 |
| time(h) | | | | | | | | |
| Heat applied | No | Yes | Yes | Yes | Yes | Yes | Yes | Yes |
| (83 C.) | | | | | | | | |
| Lid | Close | Close | Close | Close | Open | Open | Open | Close |

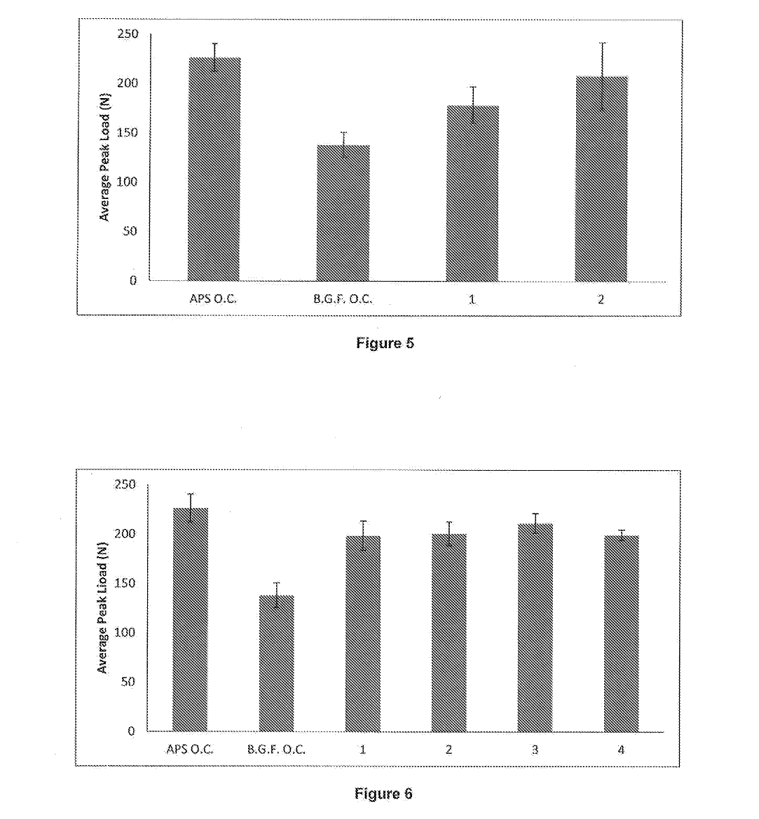

The 2% v/v APS(aq) treatment conditions used for samples 1-4, shown in FIG. 5, are set out in table 3, below.

TABLE 3

APS

| | 1 | 2 |
|---|---|---|
| pH water | Natural | Natural |
| Hydrolyzation time (h) | 24 | 1 |
| Heat applied (83 C.) | No | Yes |
| Lid | Close | Close |

The 1% or 2% v/v MPS(aq) treatment conditions used for samples 1-4, shown in FIG. 6, are set out in table 4, below.

TABLE 4

MPS

| | 1 | 2 | 3 | 4 |
|---|---|---|---|---|
| Water pH | 5 | Natural | Natural | Natural |
| Hydrolyzation | 24 | 24 | 24 | 5 |
| time (h) | | | | |
| Heat applied | No | No | No | Yes |
| (75° C.) | | | | |
| Concentration | 1% | 1% | 2% | 1% |
| Lid | Close | Close | Close | Open |

Surface treatment with silane solution was conducted in open reaction vessels and closed reaction vessels (for which the lid was opened every 2 hours to release any built-up pressure), as indicated by “lid” status shown in tables 2-4.

The results show that some of the samples treated with silane solutions at elevated temperature show peak loads which approach the peak load of the APS coated sample obtained from Owens Corning (see FIG. 2).

Single Fibre Tensile Test Results

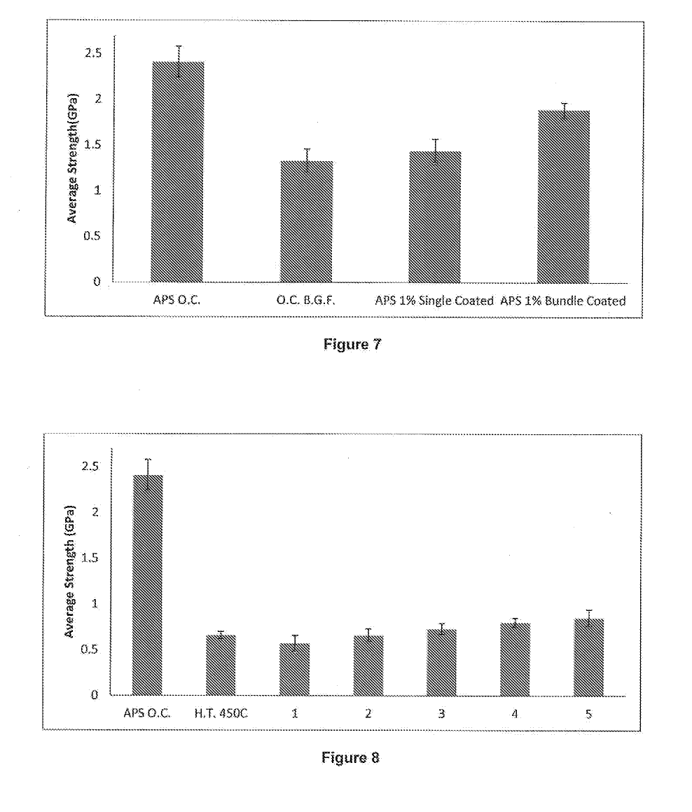

FIG. 7 shows single fibre tensile test results of single fibres obtained from a silane-treated bundle, and individual fibres which have been treated with silane. Average fibre strength (in GPa) of fibres treated within a bundle were higher. Though not wishing to be bound by theory, the inventors believe that the differences in strength may be due to a greater amount of coating formulation being applied to fibres when in the form of a bundle.

FIG. 8 shows single fibre tensile test results for fibres obtained from bundles. All three treatments result in similar single fibre strengths.

Heat Treatment

Single fibres obtained from commercially available fibre bundles of Advantex E-glass had an average tensile strength of 2.41 GPa (±0.17, within 95% confidence limits).

Following heat treatment of fibre bundles at 400° C. for 25 minutes, the fibres obtained therefrom had an average tensile strength of 1.22 GPa (±0.12, within 95% confidence limits).

It is known to separate glass fibre from a matrix material of an end of life glass fibre reinforced composite material by thermal treatment in the range of 400-700° C., for use as a filler in concrete, cement and the like. These samples can therefore also be regarded as indicative of the strength of glass fibre which has been recovered from a glass-reinforced polymer material by thermal treatment within this range.

FIGS. 2-7 also show data for an APS sized reference sample, and a bare uncoated sample, for comparison.

Treatment with Silane Coating Formulation

FIG. 8 shows average single fibre strength for fibres obtained from GF bundles following heat treatment of Owens Corning APS coated GF bundles at 450° C., and the treatments set out in Table 5, below.

TABLE 5

| | Treatment | | | | |
|---|---|---|---|---|---|
| | 1 | 2 | 3 | 4 | 5 |
| HCl 10% | 1 h | 1 h | — | — | 1 h |
| APS 1% | — | 15 min | 15 min | — | — |
| MPS 1% | — | — | — | 15 min | 15 min |

These data show that heat treatment causes a significant reduction in the mechanical strength of glass fibres, even in comparison to the individually treated fibres discussed above (see also FIG. 7).

However, as clear from the average strength of samples 2-5, the data show that in all cases a proportion of the lost mechanical strength is recovered following treatment with a silane coatings formulation.

Treatment with HCl does not appear have a positive effect on fibre strength. Whereas sample 5 (HCL+MPS) has a higher strength than sample 4 (MPS only), sample 2 (HCl+APS) has a lower strength than sample 3 (APS only). This may result from differences in pH effects on the coating deposition processes for each of the silanes.

The inventors have also shown (results not included herein) that treatment with relatively dilute HCl alone, or as a washing medium, does not cause any surface modification or result in an increase fibre strength.

Treatment with Basic Solution

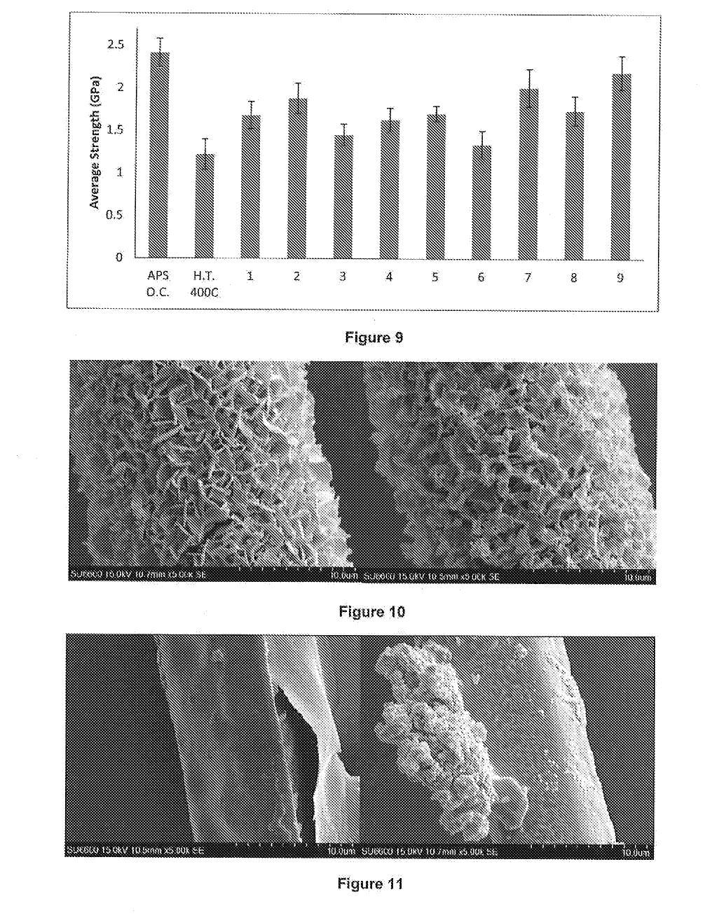

FIG. 9 shows average single fibre strength for fibres obtained from GF bundles following heat treatment of fibres obtained from GF bundles following heat treatment of Owens Corning APS coated GF bundles at 400° C., and the treatments set out in Table 6, below.

TABLE 6

| Treatment | 1 | 2 | 3 | 4 | 5 | 6 | 7 | 8 | 9 |
|---|---|---|---|---|---|---|---|---|---|
| NaOH M | — | 3 | 3 | 3 | 3 | 3 | 3 | 3 | 3 |
| NaOH Time | — | 10 | 10 | 30 | 30 | 10 | 10 | 5 | 5 |
| | | min | | min | min | min | min | min | min |
| Rinse | — | Water | Water | Water | Water | HCl | — | Water | — |
| | | | | | | 10% | | | |
| Hot APS 1% | 15 | — | 15 | — | 15 | 15 | 15 | — | 15 |
| | min | | min | | min | min | min | | min |

APS forms a basic solution in water. Thus, all samples were subject to treatment in a basic solution at elevated temperature. All samples treated in this way showed very significantly greater mechanical strength than sample 1 of FIG. 8/Table 5.

Intermediate Washing Steps

SEM images show that treatment with NaOH may leave crystalline surface deposits on the glass fibre surfaces. In order to accentuate this effect, heat treated glass fibres (400° C., 25 mins) were treated with 3M NaOH for 5 hours at 95° C.

Example SEM images of the fibre surfaces are shown in FIG. 10. The images clearly show that a crystalline material has been deposited (or grown) on the fibre surfaces. Similar deposits (in lesser amounts) have also been observed under the conditions used in some of the experiments described above. For the composition of glass fibre used in the study, this crystalline material mainly comprises water glass (sodium silicate).

Sodium silicate is soluble in acidic conditions and, as shown in FIG. 11, washing with 37% HCI(aq) removed the majority of the crystalline deposit. Washing with HCl at this concentration did not cause a reduction in fibre diameter.

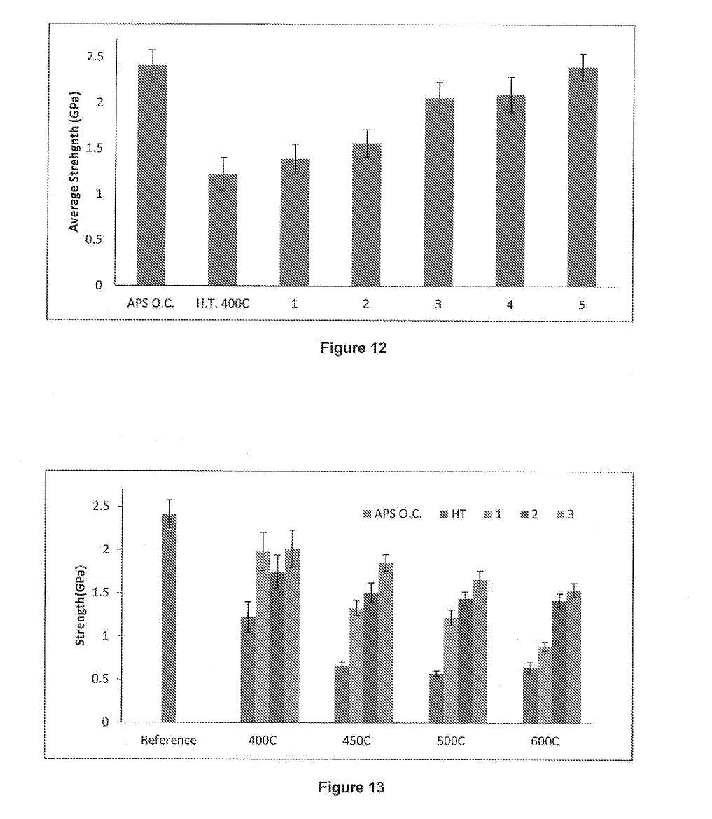

The treatments of samples 1-5 set out in Table 7, below, were applied to investigate the effect of an intermediate acid wash, between treatment with a basic solution at elevated temperature and treatment with a coating formulation. Results of single fibre tensile tests for samples 1-5 are shown in FIG. 12, and suggest that under some circumstances, an intermediate wash may be beneficial.

TABLE 7

| | Treatment | | | | |
|---|---|---|---|---|---|
| | 1 | 2 | 3 | 4 | 5 |
| NaOH M | 3 | 3 | 3 | 3 | 3 |
| NaOH Time | 3 h | 2 h | 10 min | 10 min | 10 min |
| Rinse | HCl 37% | HCl | HCl 37% | HCl 37% | HCl 37% |
| | | 37% | (Neutralised) | | |
| Hot APS 1% | — | — | 15 min | — | — |
| MPS 1% | — | 15 min | — | — | 15 min |

It is thought that these data may also demonstrate some effect of washing on the pH of the surface of the washed fibres, and therefore on in-situ reactions taking place during the subsequent treatment with the silane coating formulation.

Further experiments 1-17 on glass fibres obtained from bundles heat treated at 400° C. are detailed in Table 8.

TABLE 8

| Treatment | | (heat only) | 1 | 2 | 3 | 4 | 5 | 6 | 7 |
|---|---|---|---|---|---|---|---|---|---|
| NaOH 3M | 95 C. | — | — | 10 | 10 | 30 | 30 | 10 | 10 |
| | | | | min | min | min | min | min | min |
| HCl | rtp | — | — | — | — | — | — | 1 | — |
| 37% v/v | | | | | | | | min | |
| Water | rtp | — | — | 1 | 1 | 1 | 1 | — | — |
| | | | | min | min | min | min | | |
| | 90 C. | — | — | — | — | — | — | — | 30 |
| | | | | | | | | | min |
| | | | | | | | | | (pH 4.5) |
| APS | 5 h hydrolysis | — | 15 | — | 15 | — | 15 | 15 | 15 |
| 1% v/v | 83 C. | | min | | min | | min | min | min |
| MPS | 24 h hydrolysis, | — | — | — | — | — | — | — | — |
| 1% v/v | rtp. | | | | | | | | |
| | 5 h hydrolysis | — | — | — | — | — | — | — | — |
| | 85 C. | | | | | | | | |
| | Ave strength | 1.22 | 1.68 | 1.88 | 1.45 | 1.63 | 1.70 | 1.34 | 1.56 |
| | (Gpa) | | | | | | | | |
| | 95% conf | 0.12 | 0.16 | 0.18 | 0.13 | 0.14 | 0.09 | 0.16 | 0.16 |

| Treatment | | 8 | 9 | 10 | 11 | 12 | 13 | 14 | 15 | 16 | 17 |
|---|---|---|---|---|---|---|---|---|---|---|---|
| NaOH 3M | 95 C. | 10 | 10 | 5 | 5 | 10 | 10 | 10 | 180 | 120 | 10 |
| | | min | min | min | min | min | min | min | min | min | min |
| 37% HCl | rtp | — | — | — | — | 1 | 1 | 1 | 1 | 1 | 1 |
| | | | | | | min | min | min | min | min | min |
| Water | rtp | — | — | 1 | — | 1 | — | — | — | — | — |
| | | | | min | | min | | | | | |
| | | | | | | (pH 10) | | | | | |
| | 90 C. | 30 | — | — | — | — | — | — | — | — | — |
| | | min | | | | | | | | | |
| 1% APS | 5 h, 83 C. | 15 | 15 | — | 15 | — | — | — | — | — | — |
| | | min | min | | min | | | | | | |
| 1% MPS | 24 h, rtp | — | — | — | — | 15 | — | 15 | — | 15 | — |
| | | | | | | min | | min | | min | |
| | 5 h, 83 C. | — | — | — | — | — | — | — | — | — | 15 |
| | | | | | | | | | | | min |
| | Ave strength | 1.66 | 2.01 | 1.74 | 2.19 | 2.06 | 2.10 | 2.40 | 1.39 | 1.56 | 1.39 |
| | (Gpa) | | | | | | | | | | |
| | 95% conf | 0.16 | 0.22 | 0.17 | 0.20 | 0.17 | 0.19 | 0.15 | 0.16 | 0.15 | 0.24 |

All treatments resulted in a recovery in average tensile strength of the fibres.

Treatment at Higher Temperatures

Similar experiments were conducted on fibres obtained from fibre bundles heat treated at 450° C., 500° C. and 600° C.

It was found that average fibre strength was around 0.6 GPa lower for samples heat treated at 450° C. and above, than for those treated at 400° C. However, as shown in FIG. 13, all samples 1-3 treated as set out in Table 9 showed some recovery of mechanical strength.

TABLE 9

| NaOH 3M | HT | 1 | 2 | 3 |
|---|---|---|---|---|
| NaOH 3M (95 C.) | — | — | 10 min | 10 min |
| HCl 37% Rinsed | — | — | Yes | — |
| APS 1% (83 C.) | — | 15 min | — | 15 min |

Samples heat treated at 600° C. had similar average fibre strength to fibres treated at 500° C., but showed slightly less recovery of mechanical strength following treatment with various combinations of hot NaOH and APS

FIGS. 8, 9, 12 and 13 also show data for an APS sized reference sample, and sample of this material which has been heat treated only, for comparison.

Preparation of Fibre-Reinforce Composite Material

Fibre reinforced composite material was prepared by injection moulding polypropylene (PP) mixed with chopped glass fibres obtained from fibre bundles. The fibres were chopped 3B fibres, coated with a PP compatible APS coating (product no. DS 2200-13P), obtained from 3B-Fiberglass.

The investigated composite materials consisted of SABIC PP 579 S Polypropylene

(PP) and ‘DS 2200-13P’ chopped glass fibre strands provided by 3B fiberglass company. (SABIC is a trade mark of the Saudi Basic Industries Corporation). These glass fibres were coated with a commercial sizing which is optimized for polypropylene composites. 1% Polybond 3200 by weight of PP was added to the composites to improve the interfacial shear strength between the fibres and the PP. (Polybond is a trade mark of the Chemtura Corporation). These materials (30wt % glass fibre by composite weight) were extrusion compounded using a Betol BC25 single screw extruder. The temperatures of the five different heating zones of the extruder were set to 170° C.-220° C. The extruded material was drawn through a water bath and cut into pellets using a rotary cutter. The pelletized composite material was fed into a 25 ton Arburg Injection Moulder to produce tensile testing dog-bone shaped specimens with a geometry according to the ASTM 638 standard. Injection molded Unnotched Charpy impact test specimens were prepared according to ISO 179-1. A Tinius Olsen Impact 503 impact tester with a 25J hammer was used to perform the impact tests.

Tensile strength testing was conducted on a PP material without any glass fibre reinforcement, a material reinforced with commercially available sized glass fibre, a material mixed with commercially available glass fibre which has been heat treated at 500° C., and a material mixed with heat treated glass fibre which has been treated with aminosilane at 83° C. for 15 minutes.

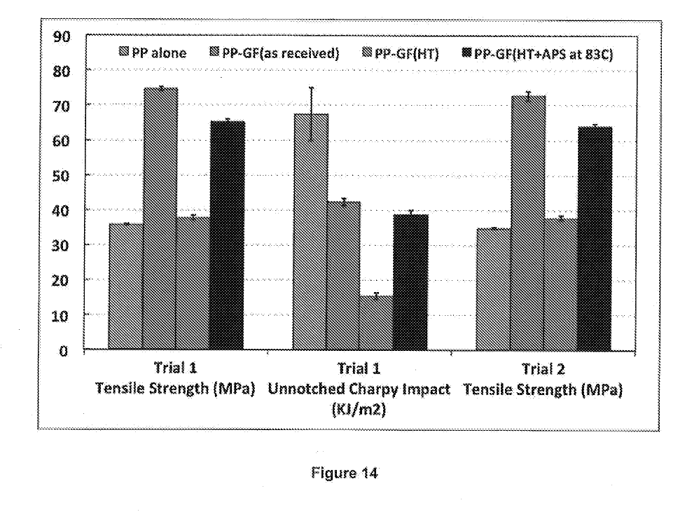

Results are shown in FIG. 14.

These data show that all materials which have been mixed with glass fibres and injection molded show greater tensile strength than the injection molded PP alone. Accordingly, the glass fibre reinforces the composite material, and does not act merely as a filler. However, the composite material with heat treated fibre (PP-GF(HT)) shows limited improvement in tensile strength over the PP material. This reflects the degradation in the physical properties of the fibres themselves, as described above.

The composite material comprising fresh commercially available glass fibre (PP+GF as received) was shown to have the greatest tensile strength (ca. 73-75 MPa), but the composite material comprising heat and basic solution treated glass fibre (PP-GF HT+APS at 83C) had a tensile strength of around 62-65 MPa.

In terms of the unnotched impact performance, PP alone is a very tough material, and adding filler or fibres is known to lower the unnotched impact strength. The composite material comprising fresh commercially available glass fibre (PP+GF as received) was shown to have the greatest composite impact strength (ca. 42 KJ/m²), the composite material with heat treated fibre (PP-GF(HT)) had a very low unnotched impact performance (ca. 15 KJ/m²), but the composite material comprising heat and basic solution treated glass fibre (PP-GF HT+APS at 83C) had an unnotched impact strength of around 39 KJ/m².

It has therefore been shown that the mechanical strength of composite materials comprising glass fibres reflects the mechanical strength of the fibres which they contain. It has also been shown that composite materials which are reinforced with heat and basic-solution treated glass fibres (i.e. fibres having similar properties to recovered, treated glass fibres) can be made which have over 80% of the strength of materials made from fresh fibres.

1. A method of treating recovered glass fibre, comprising; elevating the temperature of a basic solution; and treating the recovered glass fibre with the basic solution.

2. A method according to claim 1, comprising treating the recovered glass fibre with the basic solution at an elevated temperature.

3. A method according to claim 1, comprising elevating the temperature of the basic solution to an elevated temperature and treating the recovered glass fibre at the same or another temperature.

4. A method according to claim 1, wherein the basic solution is an aqueous solution.

5. A method according to claim 1, comprising elevating the temperature of the basic solution to from about 50° to about 100° Celsius.

6. A method according to claim 1, comprising treating the recovered glass fibre with a coating formulation.

7. A method according to claim 1, comprising treating the recovered glass fibre with a coating formulation at elevated temperature.

8. A method according to claim 1, wherein the basic solution is a coating formulation.

9. A method according to claim 6, wherein the coating formulation comprises an aqueous solution of an organosilane and a hydrolysed or partially hydrolysed organosilane.

10. A method according to claim 6, comprising elevating the temperature of a coating formulation for about 1 to about 24 hours, and treating the recovered glass fibre at the same or a different temperature.

11. A method according to claim 1, comprising one or more steps of washing the recovered glass fibre.

12. A method according to claim 11, comprising one or more intermediate washing steps.

13. A method according to claim 12, comprising washing the recovered glass fibre an acidic solution.

14. A method of recycling glass fibres from glass-fibre reinforced composite material, the method comprising; recovering glass fibre from the glass-fibre reinforced composite material; elevating the temperature of a basic solution; and treating the recovered glass fibre with the basic solution.

15. A method according to claim 14, wherein the glass fibre is recovered by a thermal treatment, comprising exposing the composite material to a temperature in the range of 400° -700° Celsius.

16. A method of preparing a glass-fibre reinforced composite material, comprising: elevating the temperature of a basic solution; treating recovered glass fibre with the basic solution; and embedding the treated, recovered glass fibre in a matrix material.

17. A method according to claim 16, comprising recovering glass fibre from a first glass-fibre reinforced composite material; elevating the temperature of a basic solution and treating the recovered glass fibre with the basic solution; and embedding the treated, recovered glass fibre in a matrix material, so as to form a second glass-fibre reinforced composite material.

18. A method according to claim 14, comprising separating the recovered glass fibre from a chemical treatment medium and/or from a matrix material or components thereof.

19. Treated, recovered glass fibre, produced by a method comprising elevating the temperature of a basic solution and treating recovered glass fibre with the basic solution.

20. Treated, recovered glass fibre produced by the method of claim 1.

21. A glass-fibre reinforced composite material, produced by a process comprising; elevating the temperature of a basic solution and treating recovered glass fibre with the basic solution; and embedding the treated, recovered glass fibre in a matrix material.

22. Treated, recovered glass fibre according to claim 19, wherein the recovered glass fibre comprises modified surface flaws selected from the group consisting of: blunted cracks; blunted flaws; etched surface regions; bridged cracks, bridged flaws, and combinations thereof.

23. Treated, recovered glass fibre according to claim 19, wherein the recovered glass fibre further comprises deposits selected from micro-scale deposits, nano-scale deposits, residual polymeric coating, and combinations thereof.

24. A glass-fibre reinforced composite material according to claim 21, wherein the recovered glass fibre comprises modified surface flaws selected from the group consisting of: eroded surface features; blunted cracks; blunted flaws; etched surface regions; bridged cracks, bridged flaws, and combinations thereof.

25. A glass-fibre reinforced composite material according to claim 21, wherein the recovered glass fibre further comprises deposits selected from micro-scale deposits, nano-scale deposits and residual polymeric coating, and combinations thereof.
